(19) United States
(12) Patent Application Publication
(10) Pub. No.: US 2009/0231713 A1
(43) Pub. Date: Sep. 17, 2009

(54) LASER POINTER VISIBILITY IMPROVING FILM, POLARIZING PLATE, IMAGE DISPLAY, AND LASER POINTER DISPLAY METHOD

(75) Inventor: Katsunori Takada, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/400,971

(22) Filed: Mar. 10, 2009

(30) Foreign Application Priority Data
Mar. 11, 2008 (JP) 2008-061735

(51) Int. Cl. G02B 5/02; G02B 1/11

(52) U.S. Cl. 359/599; 359/586

(57) ABSTRACT

A laser pointer visibility improving film that can improve visibility of a laser pointer on a display screen of an image display such as a CRT, a liquid crystal display (LCD), a plasma display panel (PDP), a electroluminescence display (ELD), etc., as well as a polarizing plate, image display, and laser pointer display method using the same. A haze value H and an arithmetic average surface roughness Ra of a viewing-side surface of the laser pointer visibility improving film satisfy a relationship of the following formula (1):

H≧−445Ra+80 (1).

### CROSS-REFERENCE TO RELATED APPLICATIONS

This application claims priority from Japanese Patent Application No. 2008-061735, filed on Mar. 11, 2008. The entire subject matter of the Japanese Patent Application is incorporated herein by reference.

### FIELD OF THE INVENTION

The present invention relates to laser pointer visibility improving films, polarizing plates, image displays, and laser pointer display methods.

### BACKGROUND OF THE INVENTION

Conventionally, for a presentation in, for example, a conference or a meeting, material images often are projected on a screen or wall using a projector. In this case, the presenter generally makes a presentation while pointing to, for example, the screen using a laser pointer that projects laser light at a certain position on a presentation image (for example, see JP 2003-234983 A (Page 2)).

In the case of screen projection using a projector, there are problems in that images projected on the screen have a reduced contrast or deteriorated quality. On the other hand, recently, the sizes of liquid crystal displays (LCDs) and plasma displays (PDPs) are increasing to exceed 70 inches and thereby it also is becoming possible to make presentations not with images projected using a projector but with images being displayed directly by such displays themselves.

However, when a presentation is made with images being displayed directly by a display, the laser light projected by a laser pointer is difficult to view because the display is self-luminous. Furthermore, when antiglare properties at the display surface are improved in order to improve visual quality of the display itself, the reflection of light projected by a laser pointer also is suppressed. This causes a problem in that the visibility of the laser pointer does not improve. Recently, a laser pointer also may be used as a pointing device that performs an instruction operation on the screen of a display (see, for example, JP 2001-236181 A) and the importance of the visibility thereof is increasing.

### SUMMARY OF THE INVENTION

An object of the present invention is intended to provide a laser pointer visibility improving film that can improve visibility of a laser pointer on a display screen of an image display, as well as a polarizing plate, image display, and laser pointer display method using the same.

In order to achieve the above-mentioned object, a laser pointer visibility improving film of the present invention is used for improving visibility of a laser pointer on a display screen of an image display, wherein the haze value H and the arithmetic average surface roughness Ra of the viewing-side surface of the film satisfy the relationship of the following formula (1):

H≧−445Ra+80 (1),

where H indicates a haze value (cloudiness) according to JIS K7136 (2000 version), and Ra indicates an arithmetic average surface roughness according to JIS B 0601 (1994 version).

A polarizing plate of the present invention is a polarizing plate including a polarizer and a laser pointer visibility improving film, wherein the laser pointer visibility improving film is the laser pointer visibility improving film of the present invention.

An image display of the present invention is an image display including a laser pointer visibility improving film or a polarizing plate, wherein the laser pointer visibility improving film is the laser pointer visibility improving film of the present invention described above, and the polarizing plate is the polarizing plate of the present invention.

A laser pointer display method of the present invention is a laser pointer display method for indicating an arbitrary position of an image display with a laser pointer, wherein a laser pointer is projected on an image display including the laser pointer visibility improving film of the present invention.

In the laser pointer visibility improving film of the present invention, the haze value H and the arithmetic average surface roughness Ra are set to the above-mentioned relationship, which makes it possible to improve visibility of a laser pointer on a display screen of an image display such as a CRT, a liquid crystal display (LCD), a plasma display panel (PDP), a electroluminescence display (ELD), etc. Accordingly, when a laser pointer visibility improving film of the present invention or a polarizing plate using the same is used in an image display, particularly, a high-resolution (high-definition) LCD, it can be an image display with excellent display properties and also can be used suitably as a presentation screen. The laser pointer visibility improving film of the present invention may be used for an image display other than a high-resolution LCD.

### BRIEF DESCRIPTION OF THE DRAWINGS

FIG. 1 is a graph made by plotting the arithmetic average surface roughness Ra and the haze value H of a laser pointer visibility improving film per result of Visibility Evaluation 1 (with a 650-nm laser used).

FIG. 2 is a graph made by plotting the arithmetic average surface roughness Ra and the haze value H of a laser pointer visibility improving film per result of Visibility Evaluation 1 (with a 532-nm laser used).

### DESCRIPTION OF THE EMBODIMENTS

As described above, in the laser pointer visibility improving film of the present invention, the haze value H and the arithmetic average surface roughness Ra have a relationship of H≧−445Ra+80. The haze value H is preferably 80% or lower, and the arithmetic average surface roughness Ra is preferably 0.5 μm or less. A haze value H of 80% or lower can prevent blurring of an image on an image display, and an arithmetic average surface roughness Ra of 0.5 μm or less can prevent white blurring of an image that is caused by scattering of reflected light. The haze value H is more preferably in the range of 5 to 80% and further preferably in the range of 15 to 75%. The arithmetic average surface roughness Ra is more preferably in the range of 0.05 to 0.5 μm and further preferably in the range of 0.07 to 0.4 μm.

The relationship between the present invention and the effect thereof is surmised as follow but the present invention is not limited by the surmise. That is, when the viewing-side surface of the film has less surface unevenness and no haze, only the laser beam light reflected by the surface returns in the specular direction. However, in the case of the laser pointer visibility improving film that satisfies the relationship between the haze value H and the arithmetic average surface roughness Ra specified in the present invention, the haze value H set in the above-mentioned range can increase the chance of scattering of laser light and the viewing-side surface of the film provided with unevenness can reflect light in directions other than the specular direction. Accordingly, visibility can be obtained even when the light of a laser pointer irradiated from an oblique direction is viewed from the front. In the laser pointer visibility improving film of the present invention, the type of the laser pointer to be used is not limited, and a semiconductor laser with a wavelength of 630 to 670 nm (a red laser pointer), a YAG laser with a wavelength of 532 nm (a green laser pointer), and various color lasers with other wavelengths can be used suitably. However, red laser light further preferably provides an effect of improving visibility.

In the laser pointer visibility improving film of the present invention, it is preferable that the film have a visibility resin layer containing fine particles on at least one surface of a transparent plastic film substrate.

The visibility resin layer containing fine particles makes it possible to easily control scattering of the laser light and the unevenness of the viewing-side surface in predetermined ranges and also to select the material and thickness of the transparent plastic film substrate. Accordingly, a laser pointer visibility improving film suitable, for example, for the environment where it is used can be obtained.

In the laser pointer visibility improving film of the present invention, it is preferable that a reflection control layer be formed on the visibility resin layer.

The reflection control layer is preferably a low refractive index layer whose refractive index is lower than that of the visibility resin layer. In the case of a presentation made in a bright environment, when a low refractive index layer with a film thickness that has been controlled is provided to form an outermost surface, the reflection intensity with respect to wavelengths other than those around that of the laser light irradiated from a laser pointer can be reduced, and thereby the contrast of the laser pointer increases and the visibility further is improved.

In this case, it is preferable that the difference in refractive index between the visibility resin layer and the low refractive index layer be at least 0.1, and the low refractive index layer have an optical thickness in the range of 60 to 110 nm, with the optical thickness being defined by the following formula (2):

Optical Thickness=Refractive Index of Low Refractive Index Layer×Film Thickness of Low Refractive Index Layer (2).

Furthermore, it also is preferable that the reflection control layer be a high refractive index layer whose refractive index is higher than that of the visibility resin layer. In the case of a presentation made in a dark environment, when a high refractive index layer with a film thickness that has been controlled is provided to form an outermost surface, the reflection intensity at wavelengths around that of the laser light irradiated from a laser pointer is increased, and thereby the contrast of the laser pointer increases and the visibility further is improved.

In this case, it is preferable that the difference in refractive index between the visibility resin layer and the high refractive index layer be at least 0.1, and the high refractive index layer have an optical thickness in the range of 150 to 240 nm, with the optical thickness being defined by the following formula (3):

Optical Thickness=Refractive Index of High Refractive Index Layer×Film Thickness of High Refractive Index Layer (3).

In the laser pointer visibility improving film of the present invention, it also is preferable that the visibility resin layer be a hard-coating layer.

Next, the present invention is described in detail. However, the present invention is not limited by the following descriptions.

Preferably, the laser pointer visibility improving film of the present invention has a visibility resin layer containing fine particles on one surface or both surfaces of a transparent plastic film substrate.

The transparent plastic film substrate is not particularly limited but is preferably one with excellent visible light transmittance (preferably with a light transmittance of at least 90%) and excellent transparency (preferably with a haze value of 1% or lower). Examples of the material for forming the transparent plastic film substrate include polyester type polymers such as polyethylene terephthalate and polyethylene naphthalate, cellulose type polymers such as diacetyl cellulose and triacetyl cellulose, polycarbonate type polymers, as well as acrylic type polymers such as polymethylmethacrylate. Furthermore, examples of the material for forming the transparent plastic film substrate also include styrene type polymers such as polystyrene and an acrylonitrile-styrene copolymer, olefin type polymers such as polyethylene, polypropylene, polyolefin that has a cyclic or norbornene structure, and an ethylene-propylene copolymer, vinyl chloride type polymers, as well as amide type polymers such as nylon and aromatic polyamide. Moreover, examples of the material for forming the transparent plastic film substrate also include imide type polymers, sulfone type polymers, polyether sulfone type polymers, polyether-ether ketone type polymers, polyphenylene sulfide type polymers, vinyl alcohol type polymers, vinylidene chloride type polymers, vinyl butyral type polymers, allylate type polymers, polyoxymethylene type polymers, epoxy type polymers, and blend polymers of the above-mentioned polymers. Among these, those having small optical birefringence are used suitably. The laser pointer visibility improving film of the present invention can be used, as a protective film, for a polarizing plate, for example. In such a case, the transparent plastic film substrate is preferably a film formed of, for example, triacetyl cellulose (TAC), polycarbonate, an acrylic polymer, or a polyolefin having a cyclic or norbornene structure. In the present invention, the transparent plastic film substrate may be a polarizer itself. Such a structure does not need a protective layer formed of, for example, TAC and provides a simple polarizing plate structure and thus allows a reduction in the number of steps for manufacturing polarizing plates or image displays and an increase in production efficiency. In addition, such a structure can provide thinner polarizing plates. When the transparent plastic film substrate is a polarizer, the visibility resin layer serves as a conventional protective layer. In such a structure, the laser pointer visibility improving film also functions as a cover plate that is attached to the surface of a liquid crystal cell.

In the present invention, the thickness of the transparent plastic film substrate is not particularly limited. For example, the thickness is preferably 10 to 500 μm, more preferably 20 to 300 μm, and most suitably 30 to 200 μm, in terms of strength, workability such as handling property, and thin layer property. The refractive index of the transparent plastic film substrate is not particularly limited. The refractive index is, for example, 1.30 to 1.80, preferably 1.40 to 1.70.

Preferably, the laser pointer visibility improving film of the present invention has a visibility resin layer containing fine particles in resin in order to further ensure visibility from the front of the light irradiated from an oblique direction, by allowing the viewing-side surface to have an uneven structure and thereby light to be reflected even in directions other than the specular direction.

Examples of the resin that forms the visibility resin layer include thermosetting resin, thermoplastic resin, ultraviolet curable resin, ionizing radiation curable resin, and two-component resin. Among these, ultraviolet curable resin that can form a visibility resin layer efficiently by a simple processing operation, specifically, by curing through ultraviolet light irradiation, is used particularly preferably. The ultraviolet curable resin is mixed with an ultraviolet polymerization initiator (photopolymerization initiator).

Examples of the ultraviolet curable resin include those of various types such as a polyester type, acrylic type, urethane type, silicone type, and epoxy type. Examples of the ultraviolet curable resin include ultraviolet curing type monomers, oligomers, and polymers. Examples of ultraviolet curable resins that are used particularly suitably include those having UV polymerizable functional groups, especially, those containing acrylic monomer or oligomer having at least two of the aforementioned functional groups, particularly, three to six of them.

Specific examples of such ultraviolet curable resin include acrylate resins such as acrylic ester of polyhydric alcohol, methacrylate resins such as methacrylic ester of polyhydric alcohol, polyfunctional urethane acrylate resin synthesized from diisocyanate, polyhydric alcohol, and hydroxyalkyl ester of acrylic acid, as well as polyfunctional urethane methacrylate resin synthesized from polyhydric alcohol and hydroxymethacrylic ester of methacrylic acid. Furthermore, for example, polyether resin, polyester resin, epoxy resin, alkyd resin, spiroacetal resin, polybutadiene resin, and polythiolpolyene resin, each of which has an acrylate type functional group, also can be used suitably as required. Moreover, melamine type resin, urethane type resin, alkyd type resin, and silicone type resin also can be used suitably.

Examples of the applicable photopolymerization initiator include 2,2-dimethoxy-2-phenylacetophenone, acetophenone, benzophenone, xanthone, 3-methylacetophenone, 4-chlorobenzophenone, 4,4′-dimethoxybenzophenone, benzoin propyl ether, benzyl dimethyl ketal, N,N,N′,N′-tetramethyl-4,4′-diaminobenzophenone, 1-(4-isopropylphenyl)-2-hydroxy-2-methylpropane-1-one, and other thioxanthone compounds.

One type of the above-mentioned resins may be used independently or two types or more of them may be mixed together to be used. Furthermore, for example, a commercial ultraviolet curable resin also can be used as the resin.

The fine particles can be inorganic or organic fine particles, for example. The inorganic fine particles are not particularly limited. Examples of the inorganic fine particles include fine particles made of silicon oxide, titanium oxide, aluminum oxide, zinc oxide, tin oxide, calcium carbonate, barium sulfate, talc, kaolin, calcium sulfate, etc. The organic fine particles are not particularly limited. Examples thereof include polymethyl methacrylate resin powder (PMMA fine particles), silicone resin powder, polystyrene resin powder, polycarbonate resin powder, acrylic-styrene resin powder, benzoguanamine resin powder, melamine resin powder, polyolefin resin powder, polyester resin powder, polyamide resin powder, polyimide resin powder, polyethylene fluoride resin powder, methyl methacrylate-styrene copolymer fine particles, etc. One type of the inorganic and organic fine particles can be used alone. Alternatively, two types or more of them can be used in combination.

The shape of the fine particles is not particularly limited. The fine particles can be in the form of substantially spherical beads or may be of an indefinite shape such as powder, for instance. The weight average particle size of the fine particles is, for example, in the range of 1 to 10 μm, preferably in the range of 3 to 8 μm. The fine particles preferably have a substantially spherical shape, more preferably a substantially spherical shape with an aspect ratio of at most 1.5.

The ratio of the fine particles to be added is not particularly limited but can be determined suitably. With respect to 100 parts by weight of the entire resin components, the ratio of the fine particles to be added is, for instance, 2 to 40 parts by weight, preferably 4 to 20 parts by weight.

From the viewpoints of preventing the occurrence of interference fringes or light scattering that is caused at the interfaces between the resin that forms the visibility resin layer and the fine particles, it is preferable that the difference in refractive index between the fine particles and the resin that forms the visibility resin layer be reduced. The interference fringes are phenomena that external light incident on the laser pointer visibility improving film is reflected to produce rainbow color. Recently, three-wavelength fluorescent lamps featuring clear visibility are frequently used in offices, for example. Under the three-wavelength fluorescent lamps, the interference fringes appear conspicuously. Since the refractive index of the visibility resin layer is generally in the range of 1.4 to 1.6, the fine particles have preferably refractive indices close to the above-mentioned refractive index range. Preferably, the difference in refractive index between the fine particles and the resin that forms the visibility resin layer is smaller than 0.05.

The difference d in refractive index between the transparent plastic film substrate and the visibility resin layer is preferably at most 0.06. When the difference d is at most 0.06, the interference fringes can be prevented from occurring. The difference d is more preferably at most 0.04.

When the visibility resin layer is a hard-coating layer, the thickness thereof is in the range of 0.5 to 30 μm and preferably in the range of 3 to 25 μm. When the thickness of the visibility resin layer exceeds 30 μm, the film tends to be curled, which causes a problem in practical use. On the other hand, when the thickness of the visibility resin layer is less than 0.5 μm, strength that is required for a hard-coating layer is not obtained satisfactorily.

The laser pointer visibility improving film of the present invention can be manufactured by, for example, preparing a material for forming a visibility resin layer including the resin, the fine particles, and a solvent; forming a coating film by applying the material for forming the visibility resin layer onto at least one surface of the transparent plastic film substrate; and forming the visibility resin layer by curing the coating film.

The solvent is not particularly limited. Examples of the solvent include dibutyl ether, dimethoxymethane, dimethoxyethane, diethoxyethane, propylene oxide, 1,4-dioxane, 1,3-dioxolane, 1,3,5-trioxane, tetrahydrofuran, acetone, methyl ethyl ketone (MEK), diethyl ketone, dipropyl ketone, diisobutyl ketone, cyclopentanone, cyclohexanone, methylcyclohexanone, ethyl formate, propyl formate, n-pentyl formate, methyl acetate, ethyl acetate, methyl propionate, ethyl propionate, n-pentyl acetate, acetyl acetone, diacetone alcohol, methyl acetoacetate, ethyl acetoacetate, methanol, ethanol, 1-propanol, 2-propanol, 1-butanol, 2-butanol, 1-pentanol, 2-methyl-2-butanol, cyclohexanol, isobutyl acetate, methyl isobutyl ketone (MIBK), 2-octanone, 2-pentanone, 2-hexanone, 2-heptanone, 3-heptanone, ethylene glycol monoethyl ether acetate, ethylene glycol monoethyl ether, ethylene glycol monobutyl ether, ethylene glycol monomethyl ether, propylene glycol monomethyl ether acetate, propylene glycol monomethyl ether, etc. One of these solvents or any combination of two or more of these solvents may be used.

Various types of leveling agents can be added to the material for forming the visibility resin layer. The leveling agent may be, for example, a fluorochemical or silicone leveling agent, preferably a silicone leveling agent. Examples of the silicon leveling agent include a reactive silicone, polydimethylsiloxane, polyether-modified polydimethylsiloxane, polymethylalkylsiloxane, etc. Among these silicone leveling agents, the reactive silicone is particularly preferred. The reactive silicone added can impart lubricity to the surface and produce continuous scratch resistance over a long period of time. In the case of using a reactive silicone containing a hydroxyl group, when a reflection control layer (a low refractive index layer) containing a siloxane component is formed on the visibility resin layer, the adhesion between the antireflection layer and the visibility resin layer is improved.

The amount of the leveling agent to be added is, for example, at most 5 parts by weight, preferably in the range of 0.01 to 5 parts by weight, with respect to 100 parts by weight of entire resin components.

If necessary, the material for forming the visibility resin layer may contain a pigment, a filler, a dispersing agent, a plasticizer, an ultraviolet absorbing agent, a surfactant, an antioxidant, a thixotropy-imparting agent, or the like, as long as the performance is not degraded. One of these additives may be used alone, or two or more of these additives may be used together.

The material for forming the visibility resin layer may be applied onto the transparent plastic film substrate by any coating method such as fountain coating, die coating, spin coating, spray coating, gravure coating, roll coating, bar coating, etc.

The material for forming the visibility resin layer is applied to form a coating film on the transparent plastic film substrate and then the coating film is cured. Preferably, the coating film is dried before being cured. The drying can be carried out by, for instance, allowing it to stand, air drying by blowing air, drying by heating, or a combination thereof.

While the coating film formed of the material for forming the visibility resin layer may be cured by any method, ultraviolet curing or ionizing radiation curing is preferably used. While any type of activation energy may be used for such curing, ultraviolet light is preferably used. Preferred examples of the energy radiation source include high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material for forming the visibility resin layer can be cured further sufficiently and the resulting visibility resin layer also has a sufficiently higher hardness. When the amount of irradiation is at most 5000 mJ/cm², the resulting visibility resin layer can be prevented from being colored and thereby can have improved transparency.

In the above-mentioned manner, the visibility resin layer is formed on at least one surface of the transparent plastic film substrate and thereby a laser pointer visibility improving film of the present invention can be produced. The laser pointer visibility improving film of the present invention may be produced by a production method other than the method described above. As described above, in the laser pointer visibility improving film of the present invention, the haze value H and the arithmetic average surface roughness Ra have the aforementioned relationship. In the present invention, the haze value H and the arithmetic average surface roughness Ra can be adjusted by any person skilled in the art without imposing an excessive amount of trial and error, by suitably setting, for example, the type of resin that forms the visibility resin layer, the thickness of the visibility resin layer, the type of the fine particles, and the weight average particle size of the fine particles.

In the laser pointer visibility improving film of the present invention, it also is preferable that the visibility resin layer also serve as a hard-coating layer. That is, the laser pointer visibility improving film of the present invention may be used as a hard-coated film. The hard-coating resin that can be used for forming a hard-coating layer can be, for example, commercial ultraviolet curable resin.

In the laser pointer visibility improving film of the present invention, a reflection control layer may be disposed on the visibility resin layer. Providing the reflection control layer allows optimal laser pointer visibility to be obtained according to the presentation environment.

The reflection control layer is allowed to exhibit the effect of improving laser pointer visibility by forming a monolayer thin optical film (reflection control layer) on the visibility resin layer. Generally, a coating method of a wet process such as fountain coating, die coating, spin coating, spray coating, gravure coating, roll coating, or bar coating is employed for forming a monolayer antireflection layer.

Examples of the material for forming a reflection control layer include: resin materials such as ultraviolet curable acrylic resins; hybrid materials with inorganic fine particles of, for example, colloidal silica dispersed in a resin; and sol-gel materials containing metal alkoxide such as tetraethoxysilane and titanium tetraethoxide. Preferably, the material contains a fluorine group in order to impart anti-fouling surface properties.

When a red laser pointer is used for a presentation in a bright room, one of the factors reducing the visibility of a laser pointer is light reflection at the interface between air and the visibility resin layer. In a bright room environment, therefore, in order to improve visibility, the reflection control layer is preferably a low refractive index layer that reduces the surface reflection with respect to wavelengths other than those around that of laser light irradiated from a laser pointer. In this case, it is preferable that the difference in refractive index between the visibility resin layer and the low refractive index layer be at least 0.1, and the low refractive index layer have an optical thickness in the range of 60 to 110 nm, with the optical thickness being defined by the refractive index of low refractive index layer×the film thickness of low refractive index layer, since these conditions can reduce the surface reflection with respect to wavelengths other than those around that of laser light.

The material for forming the low refractive index layer preferably contains hollow spherical silicon oxide ultrafine particles. The silicon oxide ultrafine particles have preferably an average particle size of 5 to 300 nm, more preferably 10 to 200 nm. The silicon oxide ultrafine particles are in the form of hollow spheres each including a pore-containing outer shell in which a hollow is formed. The hollow contains at least one of a solvent and a gas that has been used for preparing the ultrafine particles. A precursor substance for forming the hollow of the ultrafine particle preferably remains in the hollow. The thickness of the outer shell is preferably in the range of about 1 to about 50 nm and in the range of approximately 1/50 to 1/5 of the average particle size of the ultrafine particles. The outer shell preferably includes a plurality of coating layers. In the ultrafine particles, the pore is preferably blocked, and the hollow is preferably sealed with the outer shell. This is because the low refractive index layer holding a porous structure or a hollow of the ultrafine particles can have a reduced refractive index of the low refractive index layer. The method of producing such hollow spherical silicon oxide ultrafine particles is preferably a method of producing silica fine particles as disclosed in JP-A No. 2001-233611, for example.

On the other hand, when a red laser pointer is used for a presentation in a dark room, since it tends not to be subjected to an effect of surface reflection caused by outside light, the reflection control layer is preferably a high refractive index layer that increases the reflection intensity with respect to wavelengths around that of laser light irradiated from a laser pointer, in order to improve visibility of a laser pointer. In this case, it is preferable that the difference in refractive index between the visibility resin layer and the high refractive index layer be at least 0.1, and the high refractive index layer have an optical thickness in the range of 150 to 240 nm, with the optical thickness being defined by the refractive index of high refractive index layer×the film thickness of high refractive index layer, since these conditions can increase the reflection intensity with respect to wavelengths around that of laser light.

Examples of the material for forming a high refractive index layer include acrylic type resin and urethane acrylate type resin. Preferably, the refractive index of the high refractive index layer is adjusted through addition of ultrafine particles with a high refractive index. Examples of the ultrafine particles with a high refractive index include crosslinked or non-crosslinked organic ultrafine particles formed of various polymers such as polymethylmethacrylate resin (PMMA), polyurethane resin, polystyrene resin, and melamine resin, inorganic ultrafine particles of, for example, aluminum oxide, calcium oxide, titanium oxide, zirconium oxide, and zinc oxide, as well as electrically conductive inorganic ultrafine particles of, for example, tin oxide, indium oxide, cadmium oxide, antimony oxide, or compounds thereof.

When various active energy curable materials are used for the reflection control layer, the material for forming the reflection control layer is applied onto the visibility resin layer to form a coating film and the coating film is then cured. The process for curing the coating film is not particularly limited but ultraviolet curing or ionizing radiation curing is preferable. Various active energies can be used for the process, but the use of ultraviolet light is more preferable. Preferred examples of the energy radiation source include radiation sources such as high-pressure mercury lamps, halogen lamps, xenon lamps, metal halide lamps, nitrogen lasers, electron beam accelerators, and radioactive elements. The amount of irradiation with the energy radiation source is preferably 50 to 5000 mJ/cm² in terms of accumulative exposure at an ultraviolet wavelength of 365 nm. When the amount of irradiation is at least 50 mJ/cm², the material for forming the visibility resin layer can be cured further sufficiently and the resulting visibility resin layer also has a sufficiently higher hardness. When the amount of irradiation is at most 5000 mJ/cm², the resulting visibility resin layer can be prevented from being colored and thereby can have improved transparency. Preferably, the coating film is dried before being cured. The drying can be carried out by, for instance, allowing it to stand, air drying by blowing air, drying by heating, or a combination thereof.

When a thermosetting material is used for the reflection control layer, the temperature employed for drying and curing in forming the reflection control layer is not particularly limited and is, for example, in the range of 60 to 150° C. and preferably in the range of 70 to 130° C. Furthermore, after the drying and curing described above, further heating allows a laser pointer visibility improving film with a reflection control layer to be obtained. The heating temperature is not particularly limited and is, for example, in the range of 40 to 130° C. and preferably in the range of 50 to 100° C. The period of time for heating described above is not particularly limited. The heating described above can be performed by a method using, for example, a hot plate, an oven, or a belt furnace.

When a laser pointer visibility improving film with a reflection control layer is attached to an image display, the reflection control layer may frequently serve as the outermost layer and therefore tends to be susceptible to stains from the external environment. Stains are more conspicuous on the reflection control layer than on, for instance, a simple transparent plate. In the reflection control layer, for example, deposition of stains such as fingerprints, thumbmarks, sweat, and hairdressing products changes the surface reflectance, or the deposition may appear to stand out white to make the displayed content unclear. Preferably, an anti-stain layer formed of, for example, a fluoro-silane compound or a fluoro-organic compound is layered on the reflection control layer in order to prevent stains from depositing and to improve easy elimination of the stains.

With respect to the laser pointer visibility improving film of the present invention, it is preferable that at least one of the transparent plastic film substrate and the visibility resin layer be subjected to a surface treatment. When the surface treatment is performed on the transparent plastic film substrate, adhesion thereof to the visibility resin layer, the polarizer, or the polarizing plate further improves. When the surface treatment is performed on the visibility resin layer, adhesion thereof to the reflection control layer, the polarizer, or the polarizing plate further improves. The surface treatment can be, for example, a low-pressure plasma treatment, an ultraviolet radiation treatment, a corona treatment, a flame treatment, or an acid or alkali treatment. When a triacetyl cellulose film is used for the transparent plastic film substrate, an alkali treatment is preferably used as the surface treatment. This alkali treatment can be carried out by allowing the surface of the triacetyl cellulose film to come into contact with an alkali solution, washing it with water, and drying it. The alkali solution can be a potassium hydroxide solution or a sodium hydroxide solution, for example. The normal concentration (molar concentration) of the hydroxide ions of the alkali solution is preferably in the range of 0.1 N (mol/L) to 3.0 N (mol/L), more preferably 0.5 N (mol/L) to 2.0 N (mol/L).

The transparent plastic film substrate side of the laser pointer visibility improving film of the present invention is generally bonded to an optical component for use in an LCD or ELD via a pressure-sensitive adhesive or an adhesive. Before the bonding, the transparent plastic film substrate surface may also be subjected to various surface treatments as described above.

For example, the optical component can be a polarizer or a polarizing plate. A polarizing plate including a polarizer and a transparent protective film formed on one or both surfaces of the polarizer is commonly used. If the transparent protective film is formed on both surfaces of the polarizer, the front and rear transparent protective films may be made of the same material or different materials. Polarizing plates are generally placed on both surfaces of a liquid crystal cell. Polarizing plates may be arranged such that the absorption axes of two polarizing plates are substantially perpendicular to each other.

Next, an optical device including a laser pointer visibility improving film of the present invention stacked therein is described using a polarizing plate as an example. The laser pointer visibility improving film of the present invention and a polarizer or polarizing plate may be laminated with an adhesive or a pressure-sensitive adhesive to form a polarizing plate having the function according to the invention.

The polarizer is not especially limited. Examples of the polarizer include: a film that is uniaxially stretched after a hydrophilic polymer film, such as a polyvinyl alcohol type film, a partially formalized polyvinyl alcohol type film, an ethylene-vinyl acetate copolymer type partially saponified film, etc., allowed to adsorb dichromatic substances such as iodine and a dichromatic dye; and polyene type oriented films, such as a dehydrated polyvinyl alcohol film, a dehydrochlorinated polyvinyl chloride film, etc. Especially, a polarizer formed of a polyvinyl alcohol type film and a dichromatic material such as iodine is preferred because it has a high polarization dichroic ratio. Although the thickness of the polarizer is not especially limited, the thickness of about 5 to about 80 μm is commonly adopted.

A polarizer that is uniaxially stretched after a polyvinyl alcohol type film is dyed with iodine can be produced by dipping and dyeing a polyvinyl alcohol type film in an aqueous solution of iodine and then stretching it by 3 to 7 times the original length. The aqueous solution of iodine may contain boric acid, zinc sulfate, zinc chloride, etc., if necessary. Separately, the polyvinyl alcohol type film may be dipped in an aqueous solution containing boric acid, zinc sulfate, zinc chloride, etc. Furthermore, before dyeing, the polyvinyl alcohol type film may be dipped in water and rinsed if needed. Rinsing the polyvinyl alcohol type film with water allows soils and blocking inhibitors on the polyvinyl alcohol type film surface to be washed off and also provides an effect of preventing non-uniformity, such as unevenness of dyeing, that may be caused by swelling the polyvinyl alcohol type film. Stretching may be applied after dyeing with iodine or may be applied concurrently with dyeing, or conversely, dyeing with iodine may be applied after stretching. Stretching can be carried out in aqueous solutions, such as boric acid, potassium iodide, etc. or in water baths.

The transparent protective film formed on one or both surfaces of the polarizer preferably is excellent in transparency, mechanical strength, thermal stability, moisture-blocking properties, retardation value stability, or the like. Examples of the material for forming the transparent protective film include the same materials as those used for the transparent plastic film substrate.

Moreover, the polymer films described in JP-A No. 2001-343529 (WO01/37007) also can be used as the transparent protective film. The polymer films described in JP-A No. 2001-343529 are formed of, for example, resin compositions including (A) thermoplastic resins having at least one of a substituted imide group and a non-substituted imide group in the side chain thereof, and (B) thermoplastic resins having at least one of a substituted phenyl group and a non-substituted phenyl group and a nitrile group in the side chain thereof. Examples of the polymer films formed of the resin compositions described above include one formed of a resin composition including: an alternating copolymer containing isobutylene and N-methyl maleimide; and an acrylonitrile-styrene copolymer. The polymer film can be produced by extruding the resin composition in the form of film. The polymer film exhibits a small retardation and a small photoelastic coefficient and thus can eliminate defects such as unevenness due to distortion when a protective film or the like used for a polarizing plate. The polymer film also has low moisture permeability and thus has high durability against moistening.

In terms of polarizing properties, durability, and the like, cellulose resins such as triacetyl cellulose and norbornene resins are preferably used for the transparent protective film. Examples of the transparent protective film that are commercially available include FUJITAC (trade name) manufactured by Fuji Photo Film Co., Ltd., ZEONOA (trade name) manufactured by Nippon Zeon Co., Ltd., and ARTON (trade name) manufactured by JSR Corporation.

The thickness of the transparent protective film is not particularly limited. It is, for example, in the range of 1 to 500 μm in viewpoints of strength, workability such as a handling property, a thin layer property, etc. In the above range, the transparent protective film can mechanically protect a polarizer and can prevent a polarizer from shrinking and retain stable optical properties even when exposed to high temperature and high humidity. The thickness of the transparent protective film is preferably in the range of 5 to 200 μm and more preferably 10 to 150 μm.

The polarizing plate in which the laser pointer visibility improving film is stacked is not particularly limited. The polarizing plate may be a laminate of the laser pointer visibility improving film, the transparent protective film, the polarizer, and the transparent protective film that are stacked in this order or a laminate of the laser pointer visibility improving film, the polarizer, and the transparent protective film that are stacked in this order.

Laser pointer visibility improving films of the present invention and various optical devices, such as polarizing plates, including the laser pointer visibility improving films can be preferably used in various image displays such as a CRT, a liquid crystal display (LCD), a plasma display panel (PDP), a electroluminescence display (ELD), etc. The image display of the present invention has the same configuration as those of conventional image displays except for including a laser pointer visibility improving film of the present invention. In a case where the image display is a LCD, the LCD of the present invention can be manufactured by suitably assembling several parts such as a liquid crystal cell, optical components such as a polarizing plate, and, if necessity, a lighting system (for example, a backlight), and incorporating a driving circuit therein, for example. The liquid crystal cell is not particularly limited. The liquid crystal cell can be of any type such as TN type, STN type, π type, etc.

In the present invention, the configurations of liquid crystal displays are not particularly limited. The liquid crystal displays of the present invention include, for example, one in which the optical device is disposed on one side or both sides of a liquid crystal cell, one in which a backlight or a reflector is used for a lighting system, etc. In these liquid crystal displays, the optical device of the present invention can be disposed on one side or both sides of the liquid crystal cell. When disposing the optical devices in both the sides of the liquid crystal cell, they may be identical to or different from each other. Furthermore, various optical components and optical parts such as a diffusion plate, a protective plate, a prism array, a lens array sheet, an optical diffusion plate, backlight, etc. may be disposed in the liquid crystal displays.

The laser pointer display method of the present invention is a method of indicating a point by directly projecting laser light of a laser pointer onto an image display including the laser pointer visibility improving film. In the laser pointer display method, it is preferable that a laser pointer visibility improving film having a reflection control layer of a type suitable for the environment (brightness) where the an image display is to be used be selected. For instance, it is preferable that a reflection control layer with a lower refractive index than that of the visibility resin layer of the laser pointer visibility improving film be selected in a bright room environment, while it is preferable that a reflection control layer with a higher refractive index than that of the visibility resin layer of the laser pointer visibility improving film be selected in a dark room environment. The laser pointer visibility improving film may be attached according to the environment where the image display is to be used.

### EXAMPLES

Next, examples of the present invention are described together with comparative examples. However, the present invention is not limited by the following examples and comparative examples.

### EVALUATION

In the respective examples and comparative examples, various characteristics were evaluated or measured by the following methods.

### [Haze Value H]

The haze value H was measured using a Hazemeter HR300 (trade name, manufactured by Murakami Color Research Laboratory) according to haze (cloudiness) defined in JIS K7136.

### [Arithmetic Average Surface Roughness Ra]

A glass sheet (with a thickness of 1.3 mm) manufactured by MATSUNAMI GLASS IND., LTD. was bonded to the surface of the laser pointer visibility improving film on which the visibility resin layer had not been formed, with an adhesive. Then the surface shape of the visibility resin layer was measured using a high-precision micro figure measuring instrument (trade name: Surfcorder ET4000, manufactured by Kosaka Laboratory Ltd.). Thus, the arithmetic average surface roughness Ra was determined. The high-precision micro figure measuring instrument automatically calculates the arithmetic average surface roughness Ra, where Ra indicates an arithmetic average surface roughness according to JIS B 0601 (1994 version).

### [Thickness of Visibility Resin Layer]

A thickness gauge (microgauge type manufactured by Mitutoyo Corporation) was used to measure the total thickness of the laser pointer visibility improving film. The thickness of the transparent plastic film substrate was subtracted from the total thickness. Thus, the thickness of the visibility resin layer was calculated.

### [Refractive Indices of Transparent Plastic Film Substrate and Visibility Resin Layer]

The refractive indices of the transparent plastic film substrate and visibility resin layer were measured with an Abbe refractometer (trade name: DR-M4/1550, manufactured by Atago Co., Ltd.) according to the measuring method prescribed for the apparatus, with monobromonaphthalene being used for an intermediate wave, and with measuring light being allowed to be incident on the measuring planes of the transparent plastic film substrate and visibility resin layer.

### [Thickness of Reflection Control Layer]

An instantaneous multichannel photodetector system (MCPD-2000 (trade name) manufactured by Otsuka Electronics Co., Ltd.) was used and the thickness of the reflection control layer was calculated from the waveform data of the resulting interference spectrum.

### [Refractive Index of Fine Particles]

Fine particles were placed on a slide glass, and a refractive index standard solution was dropped on the fine particles. Thereafter, a cover glass was placed thereon. Thus, a sample was prepared. The sample was observed with a microscope and thereby the refractive index of the refractive index standard solution that was obtained at the point where the profiles of the fine particles were most difficult to view at the interface with the refractive index standard solution was used as the refractive index of the fine particles.

### Visibility Evaluation 1

### Examples 1 to 8 and Comparative Examples 1 to 14

(1) A black acrylic plate (with a thickness of 2.0 mm, manufactured by MITSUBISHI RAYON CO., LTD.) was bonded to the surface with no visibility resin layer formed thereon of the transparent plastic film substrate, using a pressure sensitive adhesive with a thickness of about 20 μm. Thus, a sample was prepared that had a back surface with no light reflection.
(2) Using a goniophotometer manufactured by Sigma Koki Co., Ltd., a semiconductor laser (supposed red laser pointer) with a wavelength of 650 nm and a YAG laser (supposed green laser pointer) with a wavelength of 532 nm were allowed to be incident at an incidence angle of 30°, and thereby the reflection intensity in the front direction was measured. With the reflection intensity of a film with a clear hard-coating layer produced in the reference example described later being taken as 1, the reflection intensity was judged according to the following criteria:
Judgment Criteria:
AA: a reflection intensity ratio of 5 or higher,
A: a reflection intensity ratio of 3 or higher, and
B: a reflection intensity ratio of lower than 3.

### Visibility Evaluation 2 (Evaluation in Bright Room Environment)

### Example 9

In a 300-Lx environment, a red laser pointer (laser pointer LP-050 (trade name) manufactured by PLUS Vision Corp., with a wavelength of 650 nm) was allowed to be incident at 30 degrees, and thereby the visibility was checked visually from the front direction. “G” denotes the case where the visibility improved after application of the low refractive index layer.

### Visibility Evaluation 3 (Evaluation in Dark Room Environment)

### Example 10

In a dark room, a red laser pointer (laser pointer LP-050 (trade name) manufactured by PLUS Vision Corp., with a wavelength of 650 nm) was allowed to be incident at 30 degrees, and thereby the visibility was checked visually from the front direction. “G” denotes the case where the visibility improved after application of the high refractive index layer.

### Example 1

A triacetyl cellulose film (trade name “KC4UY”, manufactured by Konica Minolta Opto, Inc., with a thickness of 40 μm) was provided as a transparent plastic film substrate. Furthermore, a material for forming a visibility resin layer was prepared as follows. That is, per 100 parts by weight of resin solid content of KZ6211 (hard-coating resin manufactured by JSR, with a solid content of 50 wt % and a refractive index of 1.49), the solid content of leveling agent (trade name “GRANDIC PC-4131” manufactured by Dainippon Ink & Chemicals, Inc., one with a solid content of 10 wt % obtained by diluting one with a solid content of 100% using ethyl acetate) was 0.5 part by weight, and 30 parts by weight of Techpolymer XX41AA (acrylic beads manufactured by Sekisui Plastics Co., Ltd., with a size of 8 μm and a refractive index of 1.505) was added thereto as fine particles. This was diluted with MIBK so that a solid content concentration of 45 wt % was obtained, which was then stirred for five minutes using an ultrasonic cleaner. Thus, the material was prepared.

The material for forming a visibility resin layer was applied to one surface of the transparent plastic film substrate using a wire bar, and thereby a coating film was formed. In this case, the thickness of the coating film was adjusted to allow the visibility resin layer to have a thickness of 10 μm. Subsequently, it was heated at 60° C. for one minute and thereby the coating film was dried. Thereafter, it was irradiated with ultraviolet light having an accumulated light intensity of 300 mJ/cm² using a high-pressure mercury lamp to be cured and thereby a 10-μm thick visibility resin layer was formed. Thus, a laser pointer visibility improving film according to this example was produced.

### Example 2

A material for forming a visibility resin layer was prepared in the same manner as in Example 1 except that 15 parts by weight of Techpolymer XX91AA (acrylic beads manufactured by Sekisui Plastics Co., Ltd., with a size of 3 μm and a refractive index of 1.545) was used as fine particles, and dilution was adjusted with ethyl acetate so that a solid content concentration of 40 wt % was obtained. Using a wire bar, the material for forming a visibility resin layer was applied to one surface of a transparent plastic film substrate similar to that used in Example 1 and thereby a coating film was formed. In this case, the thickness of the coating film was adjusted to allow the visibility resin layer to have a thickness of 13 μm. Subsequently, it was heated at 100° C. for one minute and thereby the coating film was dried. Thereafter, it was irradiated with ultraviolet light having an accumulated light intensity of 300 mJ/cm² using a high-pressure mercury lamp to be cured and thereby a 13-μm thick visibility resin layer was formed. Thus, a laser pointer visibility improving film according to this example was produced.

### Example 3

A material for forming a visibility resin layer was prepared in the same manner as in Example 1 except that 10 parts by weight of Techpolymer XX43AA (acrylic beads manufactured by Sekisui Plastics Co., Ltd., with a size of 8 μm and a refractive index of 1.525) was used as fine particles, and dilution was adjusted with MEK so that a solid content concentration of 40 wt % was obtained. Using a wire bar, the material for forming a visibility resin layer was applied to one surface of a transparent plastic film substrate similar to that used in Example 1 and thereby a coating film was formed. In this case, the thickness of the coating film was adjusted to allow the visibility resin layer to have a thickness of 13 μm. Subsequently, it was heated at 60° C. for one minute and thereby the coating film was dried. Thereafter, it was irradiated with ultraviolet light having an accumulated light intensity of 300 mJ/cm² using a high-pressure mercury lamp to be cured and thereby a 13-μm thick visibility resin layer was formed. Thus, a laser pointer visibility improving film according to this example was produced.

### Example 4

A triacetyl cellulose film (trade name “TD80UL” manufactured by FUJIFILM Corporation, with a thickness of 80 μm and a refractive index of 1.48) was provided as a transparent plastic film substrate. Furthermore, a material for forming a visibility resin layer was prepared as follows. That is, per 100 parts by weight of resin solid content of UNIDIC17-806 (ultraviolet curable resin manufactured by Dainippon Ink & Chemicals, Inc., with a solid content of 80 wt % and a refractive index of 1.53), 0.5 parts by weight of leveling agent (trade name “MEGAFACE F470” manufactured by Dainippon Ink & Chemicals, Inc.), 5 parts by weight of IRGACURE 184 (photopolymerization initiator manufactured by CIBA SPECIALTY CHEMICALS), and 14 parts by weight of Chemisnow SX350 (polystyrene particles manufactured by SOKEN CHEMICAL & ENGINEERING CO., LTD., with a size of 3.5 μm and a refractive index of 1.59) used as fine particles were added. This was diluted with toluene so that a solid content concentration of 45 wt % was obtained. Thus, the material was prepared.

The material for forming a visibility resin layer was applied to one surface of the transparent plastic film substrate using a bar coater, and thereby a coating film was formed. In this case, the thickness of the coating film was adjusted to allow the visibility resin layer to have a thickness of 5 μm. Subsequently, it was heated at 100° C. for three minutes and thereby the coating film was dried. Thereafter, it was irradiated with ultraviolet light having an accumulated light intensity of 300 mJ/cm² using a metal halide lamp to be cured and thereby a 5-μm thick visibility resin layer was formed. Thus, a laser pointer visibility improving film according to this example was produced. The visibility resin layer had a refractive index of 1.53.

### Example 5

A material for forming a visibility resin layer was prepared in the same manner as in Example 1 except that 10 parts by weight of Techpolymer XX42AA (acrylic beads manufactured by Sekisui Plastics Co., Ltd., with a size of 8 μm and a refractive index of 1.515) was used as fine particles, and adjustment was made so that a solid content concentration of 50 wt % was obtained through dilution. Using a wire bar, the material for forming a visibility resin layer was applied to one surface of a transparent plastic film substrate similar to that used in Example 1 and thereby a coating film was formed. In this case, the thickness of the coating film was adjusted to allow the visibility resin layer to have a thickness of 13 μm. Subsequently, it was heated at 80° C. for one minute and thereby the coating film was dried. Thereafter, it was irradiated with ultraviolet light having an accumulated light intensity of 300 mJ/cm² using a high-pressure mercury lamp to be cured, and thereby a 13-μm thick visibility resin layer was formed. Thus, a laser pointer visibility improving film according to this example was produced.

### Example 6

A material for forming a visibility resin layer was prepared in the same manner as in Example 3 except that dilution was adjusted with toluene. Using a wire bar, the material for forming a visibility resin layer was applied to one surface of a transparent plastic film substrate similar to that used in Example 1 and thereby a coating film was formed. In this case, the thickness of the coating film was adjusted to allow the visibility resin layer to have a thickness of 13 μm. Subsequently, it was heated at 60° C. for one minute and thereby the coating film was dried. Thereafter, it was irradiated with ultraviolet light having an accumulated light intensity of 300 mJ/cm² using a high-pressure mercury lamp to be cured, and thereby a 13-μm thick visibility resin layer was formed. Thus, a laser pointer visibility improving film according to this example was produced.

### Example 7

A laser pointer visibility improving film according to this example was produced by the same method as in Example 5 except that the thickness of the visibility resin layer was changed to 16 μm.

### Example 8

A laser pointer visibility improving film according to this example was produced by the same method as in Example 5 except that the thickness of the visibility resin layer was changed to 10 μm.

### Example 9

In this example, the laser pointer visibility improving film of Example 4 was produced and further a reflection control layer, a low refractive index layer, was formed on the visibility resin layer of the laser pointer visibility improving film. The reflection control layer was formed as follows. First, low refractive index resin (TU2217 manufactured by JSR, with a solid content of 2 wt % and a refractive index of 1.37) was provided as the material for forming a reflection control layer. This material for forming the reflection control layer was applied onto the visibility resin layer using a wire bar. It was then heated at 80° C. for one minute and thereby the coating film was dried. Thereafter, it was irradiated with ultraviolet light having an accumulated light intensity of 300 mJ/cm² using a high-pressure mercury lamp to be cured. Thus, a reflection control layer (with a refractive index of 1.37) with a thickness of 50 nm was formed.

### Example 10

In this example, the laser pointer visibility improving film of Example 4 was produced and further a reflection control layer, a high refractive index layer, was formed on the visibility resin layer of the laser pointer visibility improving film. The reflection control layer was formed as follows. First, high refractive index resin (KZ6662 manufactured by JSR, with a solid content of 49 wt % and a refractive index of 1.75) was diluted with MIBK to have a solid content of 2 wt %, which was provided as the material for forming the reflection control layer. This material for forming the reflection control layer was applied onto the visibility resin layer using a wire bar. It was then heated at 80° C. for two minutes and thereby the coating film was dried. Thereafter, it was irradiated with ultraviolet light having an accumulated light intensity of 300 mJ/cm² using a high-pressure mercury lamp to be cured. Thus, a reflection control layer (with a refractive index of 1.75) with a thickness of 120 nm was formed.

### Comparative Example 1

A laser pointer visibility improving film according to this comparative example was produced by the same method as in Example 5 except that the amount of Techpolymer XX42AA was changed to 5 parts by weight, and the thickness of the visibility resin layer was changed to 10 μm.

### Comparative Example 2

A material for forming a visibility resin layer was prepared in the same manner as in Example 1 except that 5 parts by weight of Techpolymer XX83AA (acrylic beads manufactured by Sekisui Plastics Co., Ltd., with a size of 5 μm and a refractive index of 1.525) was used as fine particles and dilution was adjusted with ethyl acetate so that a solid content concentration of 50 wt % was obtained. A laser pointer visibility improving film according to this comparative example was produced by the same method as in Example 1 except that the coating film was dried at 100° C.

### Comparative Example 3

A laser pointer visibility improving film according to this comparative example was produced by the same method as in Example 8 except that 10 parts by weight of Techpolymer XX54AA (acrylic beads manufactured by Sekisui Plastics Co., Ltd., with a size of 8 μm and a refractive index of 1.496) was used as fine particles.

### Comparative Example 4

A laser pointer visibility improving film according to this comparative example was produced by the same method as in Example 7 except that 10 parts by weight of Techpolymer XX15AA (acrylic beads manufactured by Sekisui Plastics Co., Ltd., with a size of 3 μm and a refractive index of 1.515) was used as fine particles.

### Comparative Example 5

A laser pointer visibility improving film according to this comparative example was produced by the same method as in Example 7 except that 5 parts by weight of Techpolymer XX45AA (acrylic beads manufactured by Sekisui Plastics Co., Ltd., with a size of 5 μm and a refractive index of 1.496) was used as fine particles.

### Comparative Example 6

A laser pointer visibility improving film according to this comparative example was produced by the same method as in Example 8 except that 10 parts by weight of Techpolymer XX80AA (acrylic beads manufactured by Sekisui Plastics Co., Ltd., with a size of 5 μm and a refractive index of 1.515) was used as fine particles.

### Comparative Example 7

A laser pointer visibility improving film according to this comparative example was produced by the same method as in Example 8 except that 10 parts by weight of Techpolymer XX45AA (acrylic beads manufactured by Sekisui Plastics Co., Ltd., with a size of 5 μm and a refractive index of 1.496) was used as fine particles.

### Comparative Example 8

A material for forming a visibility resin layer was prepared in the same manner as in Example 7 except that 10 parts by weight of Techpolymer XX90AA (acrylic beads manufactured by Sekisui Plastics Co., Ltd., with a size of 3 μm and a refractive index of 1.535) was used as fine particles and dilution was adjusted with ethyl acetate. A laser pointer visibility improving film according to this comparative example was produced by the same method as in Example 7 except that the coating film was dried at 60° C.

### Comparative Example 9

A material for forming a visibility resin layer was prepared in the same manner as in Example 7 except that 5 parts by weight of Techpolymer XX92AA (acrylic beads manufactured by Sekisui Plastics Co., Ltd., with a size of 5 μm and a refractive index of 1.545) was used as fine particles and dilution was adjusted with toluene so that a solid content concentration of 45 wt % was obtained. A laser pointer visibility improving film according to this comparative example was produced by the same method as in Example 7 except that the coating film was dried at 60° C.

### Comparative Example 10

A laser pointer visibility improving film according to this comparative example was produced by the same method as in Example 7 except that 10 parts by weight of Techpolymer XX79AA (acrylic beads manufactured by Sekisui Plastics Co., Ltd., with a size of 5 μm and a refractive index of 1.505) was used as fine particles.

### Comparative Example 11

A laser pointer visibility improving film according to this comparative example was produced by the same method as in Example 7 except that 15 parts by weight of Techpolymer XX89AA (acrylic beads manufactured by Sekisui Plastics Co., Ltd., with a size of 3 μm and a refractive index of 1.525) was used as fine particles and dilution was adjusted so that a solid content concentration of 45 wt % was obtained.

### Comparative Example 12

A laser pointer visibility improving film according to this comparative example was produced by the same method as in Example 7 except that 5 parts by weight of Techpolymer XX15AA (acrylic beads manufactured by Sekisui Plastics Co., Ltd., with a size of 3 μm and a refractive index of 1.515) was used as fine particles.

### Comparative Example 13

A laser pointer visibility improving film according to this comparative example was produced by the same method as in Example 8 except that 5 parts by weight of Techpolymer XX80AA (acrylic beads manufactured by Sekisui Plastics Co., Ltd., with a size of 5 μm and a refractive index of 1.515) was used as fine particles.

### Comparative Example 14

A laser pointer visibility improving film according to this comparative example was produced by the same method as in Example 1 except that 5 parts by weight of Techpolymer XX28AA (acrylic beads manufactured by Sekisui Plastics Co., Ltd., with a size of 3 μm and a refractive index of 1.496) was used as fine particles and dilution was adjusted so that a solid content concentration of 40 wt % was obtained.

### Reference Example

A triacetyl cellulose film (trade name “KC4UY”, manufactured by Konica Minolta Opto, Inc., with a thickness of 40 μm) was provided as a transparent plastic film substrate. Furthermore, a material for forming a clear hard-coating layer was prepared as follows. That is, per 100 parts by weight of resin solid content of UNIDIC17-806 (ultraviolet curable resin manufactured by Dainippon Ink & Chemicals, Inc., with a solid content of 80 wt % and a refractive index of 1.53), the solid content of leveling agent (trade name “GRANDIC PC-4131” manufactured by Dainippon Ink & Chemicals, Inc., one with a solid content of 10 wt % obtained by diluting one with a solid content of 100% using ethyl acetate) was 0.5 parts by weight, and 5 parts by weight of IRGACURE 184 (photopolymerization initiator manufactured by CIBA SPECIALTY CHEMICALS) was added thereto. This was diluted with toluene so that a solid content concentration of 50 wt % was obtained, which was then stirred for five minutes using an ultrasonic cleaner. Thus, the material was prepared.

The material for forming the clear hard-coating layer was applied to one surface of the transparent plastic film substrate using a bar coater, and thereby a coating film was formed. In this case, the thickness of the coating film was adjusted to allow the clear hard-coating layer to have a thickness of 10 μm. Subsequently, it was heated at 100° C. for three minutes and thereby the coating film was dried. Thereafter, it was irradiated with ultraviolet light having an accumulated light intensity of 300 mJ/cm² using a metal halide lamp to be cured and thereby a 10-μm thick clear hard-coating layer was formed. Thus, a film with a clear hard-coating layer according to this reference example was produced. The clear hard-coating layer had a refractive index of 1.53.

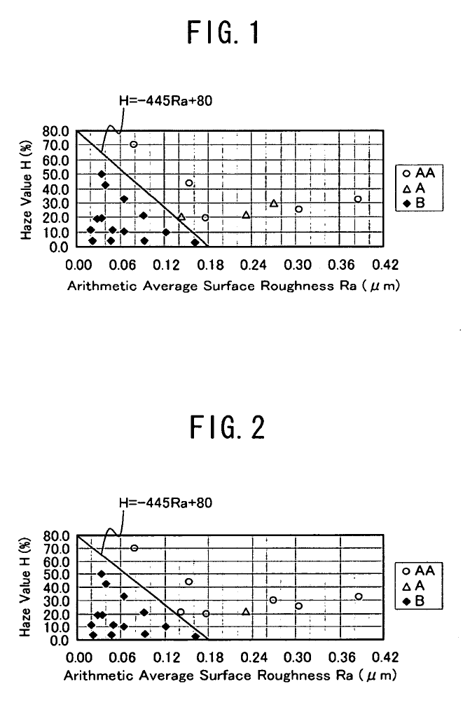

With respect to each of the laser pointer visibility improving films of the examples and comparative examples thus obtained, various properties thereof were measured or evaluated. The following Table 1 indicates the results of measurement of various properties of the respective laser pointer visibility improving films of Examples 1 to 8 and Comparative Examples 1 to 14 and results of the aforementioned Visibility Evaluation 1. Furthermore, FIGS. 1 and 2 each show a graph in which the arithmetic average surface roughness Ra and haze values H of the laser pointer visibility improving films obtained in the aforementioned examples and comparative examples are plotted on an X-Y plane where a criteria formula of Formula (1) is indicated with an oblique line, with the X axis indicating the arithmetic average surface roughness Ra of the laser pointer visibility improving film and the Y axis indicating the haze values H thereof.

TABLE 1

| | | | | Red(650 nm) | | Green(532 nm) | |
|---|---|---|---|---|---|---|---|
| | | | | Reflec- | | Reflec- | |
| | | | | tion | | tion | |
| | Ra | Haze | Calculate | Intensity | Eval- | Intensity | Eval- |
| | (μm) | H(%) | Value of H | Ratio | uation | Ratio | uation |
| Example 1 | 0.305 | 25.3 | H ≧ −55.7 | 8.96 | AA | 11.01 | AA |
| Example 2 | 0.079 | 70.1 | H ≧ 44.8 | 6.75 | AA | 14.57 | AA |
| Example 3 | 0.386 | 32.2 | H ≧ −91.8 | 5.07 | AA | 7.38 | AA |
| Example 4 | 0.154 | 43.8 | H ≧ 11.5 | 5.15 | AA | 9.22 | AA |
| Example 5 | 0.177 | 19.8 | H ≧ 1.2 | 6.42 | AA | 10.01 | AA |
| Example 6 | 0.270 | 29.7 | H ≧ −40.2 | 3.68 | A | 12.12 | AA |
| Example 7 | 0.143 | 21.0 | H ≧ 16.4 | 4.60 | A | 7.09 | AA |
| Example 8 | 0.232 | 21.9 | H ≧ −23.2 | 3.51 | A | 4.48 | A |
| Comparative | 0.122 | 10.0 | H ≧ 25.7 | 2.10 | B | 2.89 | B |
| Example 1 | | | | | | | |
| Comparative | 0.035 | 19.3 | H ≧ 64.4 | 2.49 | B | 2.23 | B |
| Example 2 | | | | | | | |
| Comparative | 0.162 | 2.7 | H ≧ 7.9 | 1.89 | B | 2.49 | B |
| Example 3 | | | | | | | |
| Comparative | 0.029 | 19.2 | H ≧ 67.1 | 1.58 | B | 2.07 | B |
| Example 4 | | | | | | | |
| Comparative | 0.047 | 3.9 | H ≧ 59.1 | 1.54 | B | 2.29 | B |
| Example 5 | | | | | | | |
| Comparative | 0.092 | 21.1 | H ≧ 39.1 | 1.69 | B | 1.79 | B |
| Example 6 | | | | | | | |
| Comparative | 0.093 | 4.3 | H ≧ 38.6 | 1.82 | B | 2.69 | B |
| Example 7 | | | | | | | |
| Comparative | 0.034 | 49.9 | H ≧ 64.9 | 1.92 | B | 1.61 | B |
| Example 8 | | | | | | | |
| Comparative | 0.065 | 32.7 | H ≧ 51.1 | 1.28 | B | 1.51 | B |
| Example 9 | | | | | | | |
| Comparative | 0.065 | 10.4 | H ≧ 51.1 | 1.21 | B | 1.51 | B |
| Example 10 | | | | | | | |
| Comparative | 0.040 | 42.7 | H ≧ 62.2 | 1.39 | B | 1.51 | B |
| Example 11 | | | | | | | |
| Comparative | 0.020 | 11.4 | H ≧ 71.1 | 1.11 | B | 1.41 | B |
| Example 12 | | | | | | | |
| Comparative | 0.049 | 11.3 | H ≧ 58.2 | 1.15 | B | 1.39 | B |
| Example 13 | | | | | | | |
| Comparative | 0.022 | 4.1 | H ≧ 70.2 | 1.97 | B | 1.55 | B |
| Example 14 | | | | | | | |
| Reference | 0.003 | 0.4 | — | 1.00 | — | 1.00 | — |
| Example | | | | | | | |

As shown in Table 1 above, all the laser pointer visibility improving films of the examples that satisfy the relationship of formula (1) allowed reflection intensity in the front direction to be obtained sufficiently even with respect to light irradiation from oblique directions at both wavelengths employed for supposed red and green laser pointers, and therefore were excellent in visibility. On the other hand, with respect to the laser pointer visibility improving films of the comparative examples, the visibilities of both the red and green laser pointers were not sufficient.

Table 2 indicates the results of Visibility Evaluation 2 described above with respect to the laser pointer visibility improving film obtained in Example 9 and Visibility Evaluation 3 described above with respect to the laser pointer visibility improving film obtained in Example 10.

TABLE 2

| | | | | Reflection | | | |
|---|---|---|---|---|---|---|---|
| | Refractive Index | | | Control Layer | | Visibility | |
| | | Reflec- | | | Optical | Evaluation | |
| | Visibility | tion | Difference | Thick- | Thick- | Eval- | Eval- |
| | Resin | Control | (absolute | ness | ness | uation | uation |
| | Layer | Layer | value) | (nm) | (nm) | 2 | 3 |
| Example 9 | 1.53 | 1.37 | 0.16 | 50 | 68.5 | G | — |
| Example 10 | 1.53 | 1.75 | 0.22 | 120 | 210.0 | — | G |

As indicated in Table 2 above, the laser pointer visibility improving film obtained in Example 9 had improved visibility in a bright room as compared to that obtained in Example 4. The laser pointer visibility improving film obtained in Example 10 had improved visibility in a dark room as compared to that obtained in Example 4.

The laser pointer visibility improving film of the present invention has excellent antiglare properties and excellent laser pointer visibility even when the image display concerned is used as a presentation screen. Accordingly, the laser pointer visibility improving film of the present invention can be suitably used, for example, for optical elements such as polarizing plates, and various image displays such as CRTs, LCDs, PDPs, and ELDs. It has no limitation in application and is applicable across a wide field of uses.

What is claimed is:

1. A laser pointer visibility improving film that is used for improving visibility of a laser pointer on a display screen of an image display,
wherein a haze value H and an arithmetic average surface roughness Ra of a viewing-side surface of the film satisfy a relationship of the following formula (1):
H≧−445Ra+80 (1),
where H indicates a haze value (cloudiness) (%) according to JIS K7136 (2000 version), and
Ra indicates an arithmetic average surface roughness (μm) according to JIS B 0601 (1994 version).

2. The laser pointer visibility improving film according to claim 1, wherein the haze value H is 80% or lower and the arithmetic average surface roughness Ra is 0.5 μm or less.

3. The laser pointer visibility improving film according to claim 1, wherein the film comprises a transparent plastic film substrate and a visibility resin layer containing fine particles on at least one surface of the transparent plastic film substrate.

4. The laser pointer visibility improving film according to claim 3, further comprising a reflection control layer formed on the visibility resin layer.

5. The laser pointer visibility improving film according to claim 4, wherein the reflection control layer is a low refractive index layer whose refractive index is lower than that of the visibility resin layer.

6. The laser pointer visibility improving film according to claim 5, wherein a difference in refractive index between the visibility resin layer and the low refractive index layer is at least 0.1, and the low refractive index layer has an optical thickness in a range of 60 to 110 nm, with the optical thickness being defined by the following formula (2):
Optical thickness=Refractive index of low refractive index layer×Film thickness of low refractive index layer (2).

7. The laser pointer visibility improving film according to claim 4, wherein the reflection control layer is a high refractive index layer whose refractive index is higher than that of the visibility resin layer.

8. The laser pointer visibility improving film according to claim 7, wherein a difference in refractive index between the visibility resin layer and the high refractive index layer is at least 0.1, and the high refractive index layer has an optical thickness in a range of 150 to 240 nm, with the optical thickness being defined by the following formula (3):
Optical thickness=Refractive index of high refractive index layer×Film thickness of high refractive index layer (3).

9. The laser pointer visibility improving film according to claim 3, wherein the visibility resin layer is a hard-coating layer.

10. A polarizing plate comprising a polarizer and a laser pointer visibility improving film,
wherein the laser pointer visibility improving film is a laser pointer visibility improving film according to claim 1.

11. An image display comprising a laser pointer visibility improving film,
wherein the laser pointer visibility improving film is a laser pointer visibility improving film according to claim 1.

12. A laser pointer display method for indicating an arbitrary position of an image display with a laser pointer,
comprising projecting a laser pointer on the image display,
wherein the image display comprises a laser pointer visibility improving film according to claim 1.

13. An image display comprising a polarizing plate,
wherein the polarizing plate is a polarizing plate according to claim 10.

14. The polarizing plate of claim 10, wherein the polarizing plate is:
a laminate of
the laser pointer visibility improving film,
a transparent protective film,
the polarizer, and
a transparent protective film
stacked in this order;
or
a laminate of
the laser pointer visibility improving film,
the polarizer, and
a transparent protective film
stacked in this order.

15. The laser pointer visibility improving film according to claim 3, wherein the refractive index of the visibility resin layer is in the range of 1.4 to 1.6.

16. The laser pointer visibility improving film according to claim 3, the difference in refractive index between the fine particles and the resin that forms the visibility resin layer is smaller than 0.05.

17. The laser pointer visibility improving film according to claim 3, wherein the difference d in refractive index between the transparent plastic film substrate and the visibility resin layer is at most 0.06.
